(19) United States
(12) Patent Application Publication
(10) Pub. No.: US 2015/0073064 A1
(43) Pub. Date: Mar. 12, 2015

(54) HIGHLY CRYSTALLINE AND FROTHED POLYOLEFIN FOAM

(71) Applicant: Kimberly-Clark Worldwide, Inc., Neenah, WI (US)

(72) Inventors: Jian Qin, Appleton, WI (US); Charles Wilson Colman, Marietta, GA (US); Deborah Joy Calewarts, Winneconne, WI (US); Palaniraj Ramaswami Wallajapet, Neenah, WI (US)

(73) Assignee: Kimberly-Clark Worldwide, Inc., Neenah, WI (US)

(21) Appl. No.: 14/024,812

(22) Filed: Sep. 12, 2013

(51) Int. Cl. C08J 9/30

(52) U.S. Cl. CPC C08J 9/30
USPC 521/84.1; 521/143; 521/134; 521/139; 521/140; 521/97; 521/89; 521/96

(57) ABSTRACT

A frothed polymer foam including a highly crystalline polyolefin dispersion, a cross-linkable binder and a surfactant. A process of manufacturing a frothed polymer foam including a highly crystalline polyolefin dispersion, a cross-linkable binder and a surfactant.

### BACKGROUND

Open cell foam is a desirable material in products which acquire and/or distribute aqueous fluids, such as diapers, training pants, youth pants, feminine hygiene products, adult incontinence garments and pads, wiping towels, sponges, wound dressings, surgical sponges, and the like. Open cell foam may also find use in other applications, such as fluid filtration, insulation applications, sound absorption, sound deadening, carpet and fabric backing, heat or cold insulation, and cushioning. One type of open cell foam, frothed polyolefin foam, can exhibit desirable benefits such as low density, good softness, high absorbency, and low cost when compared with other types of foam such as polyurethane foam and high internal phase emulsion foam.

The manufacturing process to produce frothed polyolefin foam requires both frothing and drying process steps. In order to obtain useable frothed polyolefin foam following the frothing and drying process steps, the polyolefin polymer needs to have a very low degree of crystallinity in order to have a broad range of a softening profile to enable its dispersion particles to stick together during the drying process. Conversely, highly crystalline polyolefin polymer dispersion will have a very sharp melting phase transition point without a gradual softening process. For highly crystalline polyolefin polymer having such thermo-behavior, the drying process can produce either 1) a dried powdery foam with no integrity due to no bonds formed between dispersion particles when it is dried at a temperature below its melting point, or 2) a solid polymer film with no internal pores and voids due to polymer melting at a temperature equal to or higher than its melting point.

There are generally two types of polyolefin polymer dispersions. The first type is a dispersion comprising a pure polymer. The pure polymer, therefore, is not a copolymer or an interpolymer. Since the pure polyolefin polymer is a linear polymer and highly flexible, it can form highly ordered supermolecular structures. Pure polyolefin polymers, therefore, have high degree of crystallinity. To achieve the low degree of crystallinity needed to successfully manufacture frothed polyolefin foam using pure polyolefin polymer, the pure polyolefin polymer needs to comprise a co-monomer to disrupt its supermolecular order and prevent it from forming a highly ordered crystalline structure. The polyolefin copolymer is the second general type of polyolefin polymer dispersion. A polyolefin copolymer tends to not form a crystalline structure and its supermolecular structure remains in a random dis-ordered structure (i.e., a so-called amorphous structure). Copolymerization, however, adds cost to the polymer dispersion materials as well as the different process of making the polymers.

There is a need for frothed polyolefin foam developed from highly crystalline polyolefin polymer dispersions. There is a need for a manufacturing process for making frothed polyolefin foam developed from high crystalline polyolefin polymer dispersions.

### SUMMARY

In an embodiment, an open cell foam can comprise a composition comprising a highly crystalline polyolefin dispersion; a cross-linkable binder; and a surfactant. In an embodiment, the polyolefin can be selected from polyethylene or polypropylene. In an embodiment, the binder can be water soluble. In an embodiment, the binder can be selected from carboxymethyl cellulose or modified protein. In an embodiment, the binder can be water dispersible. In an embodiment, the binder is selected from polyisoprene, vinyl acetate-ethylene copolymer, or styrene-butadiene rubber. In an embodiment, the binder can be cross-linked using a cross-linking agent. In an embodiment, the cross-linking agent can be selected from sulfur compounds, peroxides, persulfates, azo compounds, ethylene carbonate, propylene carbonate, ammonium zirconium carbonate, organic peroxides and inorganic peroxides. In an embodiment, the binder can be cross-linked using radiation or electromagnetism. In an embodiment, the foam can further comprise fibers, non-swellable particles or combinations thereof.

In an embodiment, a method of manufacturing an open cell foam can comprise the steps of producing a composition comprising a highly crystalline polyolefin dispersion, a surfactant, a cross-linkable binder, and a cross-linking agent; mechanically mixing the composition with air to create a froth; and drying the froth at a temperature below the melting point of the open cell foam and above the temperature at which the cross-linking agent can cross-link the binder. In an embodiment, the polyolefin can be selected from polyethylene or polypropylene. In an embodiment, the binder can be water soluble. In an embodiment, the binder can be selected from carboxymethyl cellulose or modified protein. In an embodiment, the binder can be water dispersible. In an embodiment, the binder can be selected from polyisoprene, vinyl acetate-ethylene copolymer, or styrene-butadiene rubber. In an embodiment, the binder can be cross-linked using a cross-linking agent. In an embodiment, the cross-linking agent can be selected from sulfur compounds, peroxides, persulfates, azo compounds, ethylene carbonate, propylene carbonate, ammonium zirconium carbonate, organic peroxides and inorganic peroxides. In an embodiment, the binder can be cross-linked using radiation or electromagnetism. In an embodiment, the open cell foam can further comprise fibers, non-swellable particles or combinations thereof.

### BRIEF DESCRIPTION OF THE DRAWINGS

FIG. 1 is a melting curve, heat flow in watts/gram (W/g) plotted against temperature (in deg Celsius) on the x-axis, obtained by first differential scanning calorimetry (DSC) for the polyethylene copolymer designated as HYPOD® 8510.

FIG. 2 is a melting curve, heat flow in watts/gram (W/g) plotted against temperature (in deg Celsius) on the x-axis, obtained by first differential scanning calorimetry (DSC) for the pure polyethylene dispersion designated as Michem® Shield 251.

FIG. 3 is a melting curve, heat flow in watts/gram (W/g) plotted against temperature (in deg Celsius) on the x-axis, obtained by first differential scanning calorimetry (DSC) for the pure polyethylene dispersion designated as Michem® Guard 55.

FIG. 4 is a meting curve, heat flow in watts/gram (W/g) plotted against temperature (in deg Celsius) on the x-axis, obtained by first differential scanning calorimetry (DSC) for the pure polyethylene dispersion designated as Hydrocer 257.

FIG. 5 is a photographic comparison, before, during and after finger touch, of frothed polyolefin foam manufactured with the polyethylene copolymer designated as HYPOD® 8510 and frothed polyolefin foam manufactured with the pure polyethylene dispersion designated as Michem® Guard 55.

FIG. 6 is a photographic comparison, before, during and after finger touch, of frothed polyolefin foam manufactured with the polyethylene copolymer designated as HYPOD® 8510 and frothed polyolefin foam manufactured with the pure polyethylene dispersion designated as Hydrocer 257 and having a binder.

FIG. 7 is a photographic comparison, before and during bending, of frothed polyolefin foam manufactured with the polyethylene copolymer designated as HYPOD® 8510 and frothed polyolefin foam manufactured with the pure polyethylene dispersion designated as Hydrocer 257 and having a binder.

FIG. 8 is a photographic comparison, before, during and after finger touch, of frothed polyolefin foam manufactured with the polyethylene copolymer designated as HYPOD® 8510 and frothed polyolefin foam manufactured with the pure polyethylene dispersion designated as Hydrocer 257 and having a cross-linked binder.

### DETAILED DESCRIPTION

In an embodiment, the present disclosure is generally directed towards open cell foam which has been manufactured via a frothing process using highly crystalline polyolefin polymer dispersions.

### DEFINITIONS

The term “closed cell foam” refers herein to the gas formed discrete pockets within the foam, each pocket completely surrounded by solid material.

The term “dispersion” refers herein to a two phase liquid/polymer composition where the aqueous phase is normally the continuous phase and the polymer is suspended therein in a stable fashion, such as with the aid of a dispersing agent/dispersant so that the polymer will remain dispersed prior to and at least as long as it will require to complete the frothing and drying steps. In an embodiment, the polymer can remain dispersed throughout the frothing and drying process so that a complete process can be conducted, either batch-wise or in a continuous fashion, without the polymer settling out of the dispersion.

The term “drying” refers herein to a process of causing a froth to become dry foam and the term “dry” refers herein to the elimination of at least about 95% of the water from the froth.

The term “foam” refers herein to a durable structure that is formed by trapping pockets of gas in a liquid or solid. Usually the volume of gas in the foam is large with thin films of liquid or solid separating the regions of gas.

The term “froth” refers herein to an aqueous dispersion of the polymer which has been frothed before drying.

The terms “frothing” or “frothed” refers herein to a process of incorporating substantial volumes of air, or other gas, in a liquid where at least about 80, 85, or 90 volume percent of the frothed material consists of the gaseous component. It is to be understood that the aqueous liquid can be a molecular solution, a micellar solution, or dispersion. In general, the froth can be created by mechanical methods such as high shear mixing under atmospheric conditions or optionally injecting gas into the system while mixing.

The term “open cell foam” refers herein to gas pockets connecting with each other. A liquid can easily flow through the entire structure of open cell foam displacing the air. An open cell foam can have an open cell content of at least about 80, 85, or 90%, as determined by and according to ASTM D2856-A.

The term “surfactant” refers herein to a compound that lowers the surface tension of a liquid, the interfacial tension between two liquids, or the tension between a liquid and a solid. Surfactants may act as detergents, wetting agents, emulsifiers, foaming agents, and dispersants.

### Polymer Dispersion:

Frothable compositions of polyolefin polymers may be in the form of dispersions. The polyolefin polymers that are solids, such as powder and granules, may be converted into a frothable dispersion by mixing it with water and, if necessary, dispersant(s), under certain processing conditions such as high pressure extrusion at an elevated temperature. The polyolefin polymer dispersion can then be mixed with air or a frothing surfactant to convert it into froth.

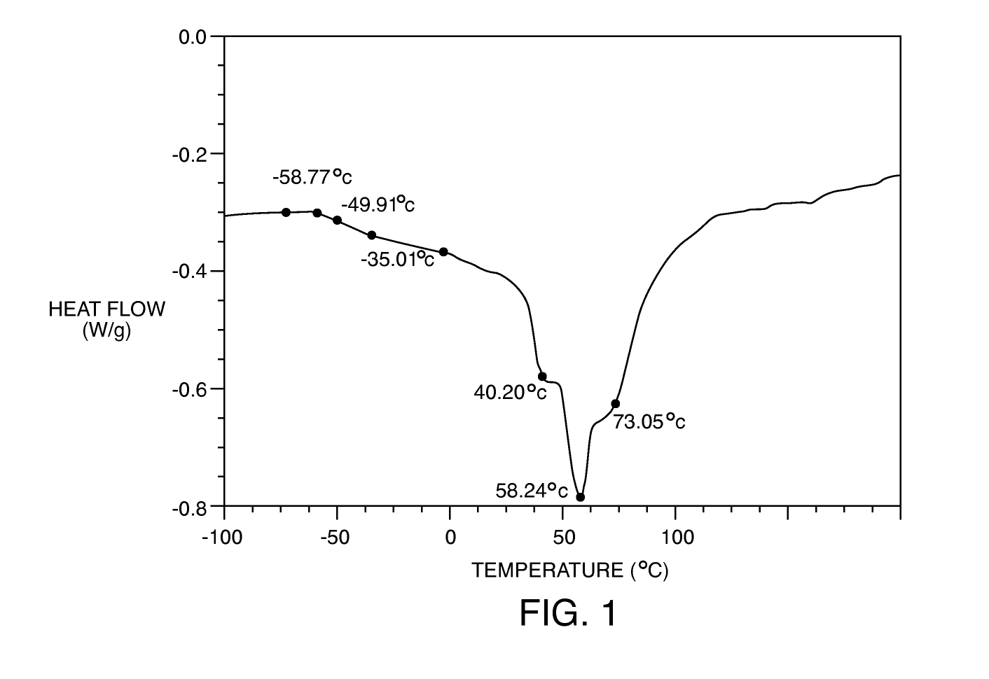

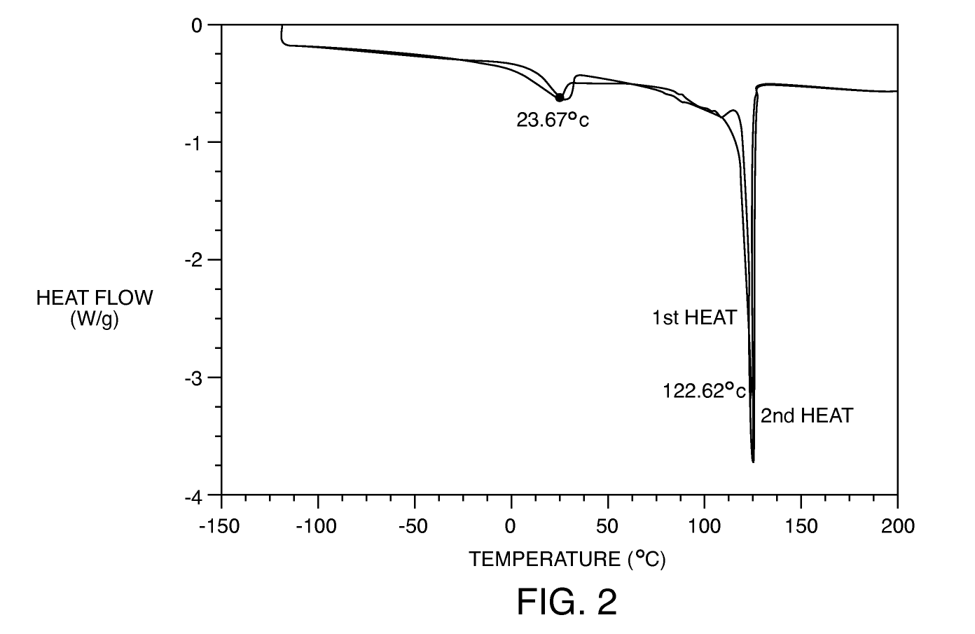

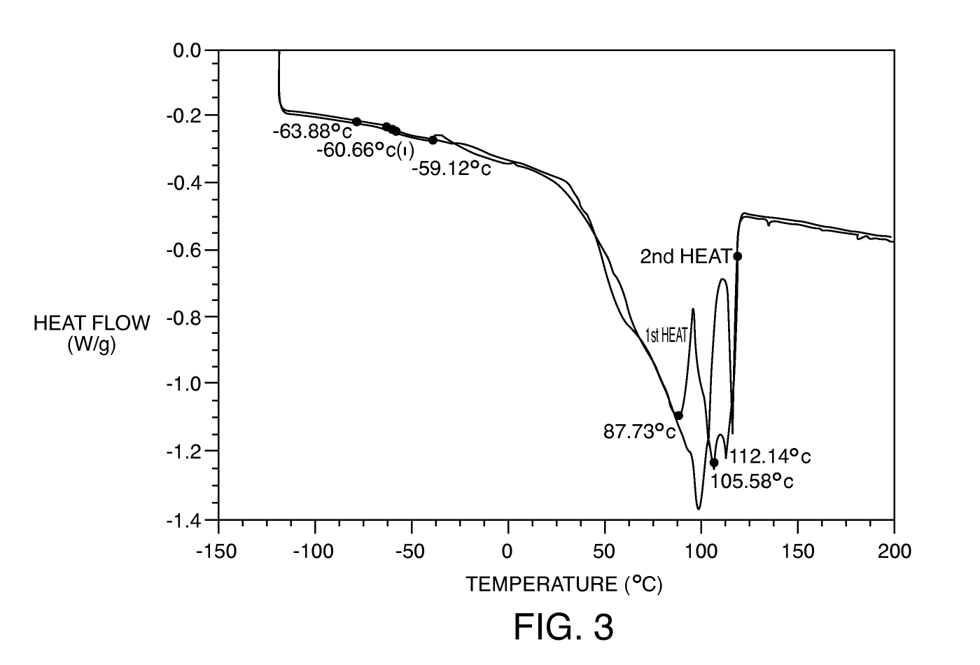

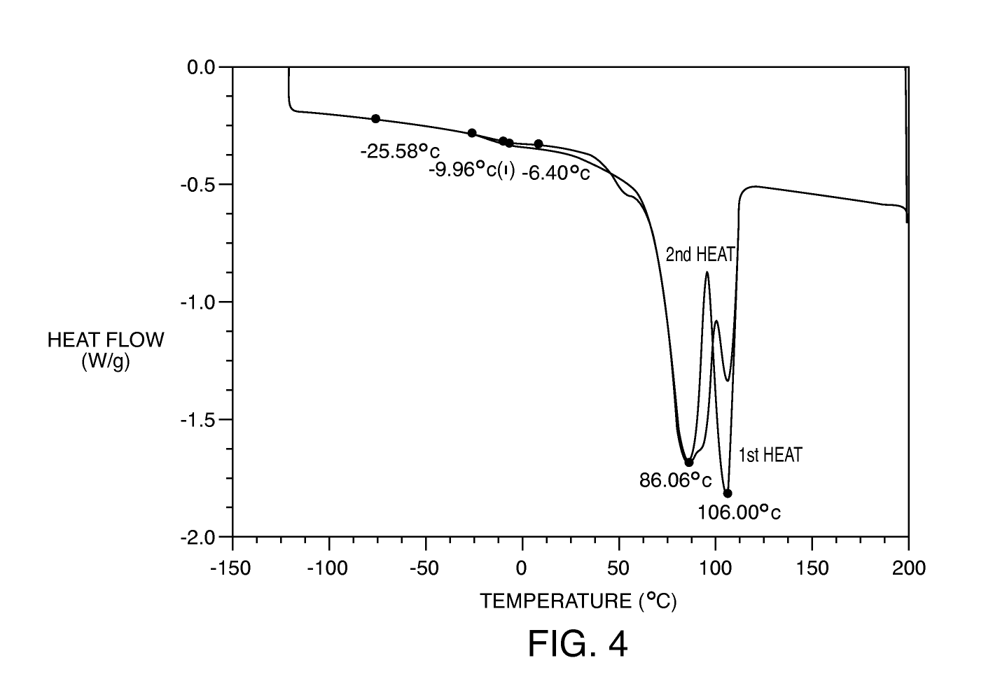

The polymer dispersion can include a polyolefin polymer. The polyolefin polymer can be highly crystalline polyolefin polymer. In an embodiment, the polyolefin polymer can be a pure polyolefin polymer. In such an embodiment, the pure polyolefin polymer is not a copolymer or interpolymer. In an embodiment, the polyolefin polymer can be highly crystalline pure polyolefin polymer. In an embodiment, the polyolefin polymer can be characterized by exhibiting a particular type of differential scanning calorimetry (DSC) plot of the polyolefin endotherm. In such an embodiment, the observed endotherm can exhibit what is generally considered to be a sharp melting point. FIGS. 2-4 provide non-limiting examples of the polyolefin endotherm of three exemplary highly crystalline pure polyolefin polymers. FIG. 2 is a polyolefin endotherm of pure polyethylene dispersion commercially available from Michelman and designated as Michem® Shield 251. FIG. 3 is a polyolefin endotherm of pure polyethylene dispersion commercially available from Michelman and designated as Michem® Guard 55. FIG. 4 is a polyolefin endotherm of pure polyethylene dispersion commercially available from Shamrock and designated as Hydrocer 257. Conversely, FIG. 1 is an endotherm of polyethylene copolymer dispersion commercially available from Dow Chemical Co. and designated as HYPOD 8510. The polyethylene copolymer (FIG. 1) exhibits a broad melting range rather than the sharp melting point of the highly crystalline pure polyolefin polymers (FIGS. 2-4). Examples of highly crystalline polyolefin polymers include, but are not limited to, polyethylene and polypropylene. A pure polypropylene can be either highly or low crystalline dependent upon its tacticity. The relative orientation of each methyl group (CH₃) relative to the methyl groups in neighboring monomer units has a strong effect on the polymer's ability to form crystals. A high crystalline polypropylene has either an isotactic or syndiotactic tacticity.

The polyolefin polymer dispersion can include a dispersant. The dispersant can be present in an amount from about 1, 2 or 3% to about 5, 8, or 10%, based upon the weight of the aqueous dispersion of the polymer dispersion. The dispersant utilized to stabilize the polymer particles in the polymer dispersion can vary dependent upon the selection of the polyolefin polymer. The dispersant can be the same as or different from the frothing surfactant in the subsequent preparation of the froth.

### Froth:

To produce the frothed polyolefin foam, the polymer dispersion is converted into froth.

The polymer dispersion, together with other components, such as a binder and an optional cross-linking agent, is frothed by mechanical agitation in the presence of a foaming composition and air. A foaming composition comprises at least one frothing surfactant or a combination of several frothing surfactants that may be added into the polymer dispersion to achieve at least one of four functional goals: foaming capability (to improve the polymer dispersion's capability of entrapping total amount of air), stabilizing functionality (to improve containment of the entrapped air during the drying step), wetting characteristics (to enhance fluid wettability of the dried frothed polyolefin foam), and gelation capability in the froth (to improve resiliency after deformation). A variety of frothed polyolefin foams can be manufactured depending on the type of frothed polyolefin foam and functionality sought. For example, soft and bulky frothed polyolefin foam may be made by agitating the polyolefin dispersion with a binder, an optional cross-linking agent, air and a foaming composition comprising at least one frothing surfactant to deliver foaming and stabilization. Alternatively, soft, bulky, and wettable frothed polyolefin foam may be made by agitating the polyolefin dispersion with a binder, an optional cross-linking agent, air and a foaming composition comprising at least one frothing surfactant or a combination of several frothing surfactants in order to achieve a frothed polyolefin foam that is capable of delivering foaming, stabilization, and wettability functions.

Creating and stabilizing the froth during the frothing and drying step can, therefore, be accomplished by the addition of a foaming surfactant, binder, and an optional cross-linking agent to the polyolefin dispersion when initially creating the froth. In addition, the frothing surfactant can improve aqueous wetting, if desired. Suitable frothing surfactants can be selected from, but are not limited to, cationic, anionic and nonionic surfactants.

Cationic surfactants include, but are not limited to, primary amine salts, diamine salts, quaternary ammonium salts and ethoxylated amines may be used, as may nonionic surfactants such as alkylphenol ethyoxylates, and linear and secondary alcohol ethoxylates of alkyl group containing more than 8 carbon atoms.

Anionic surfactants that can be used in the preparation of the froth can include, but are not limited to, carboxylic acid salts and ester amides of carboxylic fatty acids, fatty acids comprising from 12-36 carbon atoms such as stearic or lauric acid, palmitic, myristic, oleic, linoleic, ricinoleic, erucic acid, fatty acids comprising from 12-24 carbon atoms and their alkali metal (e.g., sodium or potassium), and alkanolamine or ammonium salts. When a good “hand” or fabric like feel is desired in the finished frothed polyolefin foam, a saturated fatty acid derivative (e.g., the salt of stearic or palmitic acid) can be employed. Other suitable anionic surfactants include alkylbenzene sulfonates, secondary n-alkane sulfonates, alpha-olefin sulfonates, dialkyl diphenylene oxide sulfonates, sulfosuccinate esters, isethionates, linear alkyl (alcohol) sulfates and linear alcohol ether sulfates.

The frothing surfactants can also be divided into four categories depending on function: (1) Air Entrapment Agent—used to enhance a liquid's (dispersion, solution, etc.) capability to entrap air which can be measured by determining a “blow ratio.” Examples of air entrapment agents include, but are not limited to, potassium laurate, sodium lauryl sulfate, ammonium lauryl sulfate, ammonium stearate, potassium oleate, disodium octadecyl sulfosuccinimate, hydroxypropyl cellulose, and combinations thereof; (2) Stabilization Agent—used to enhance the stability of froth air bubble against time and temperature.

Examples of stabilizing agents include, but are not limited to, sodium lauryl sulfate, ammonium stearate, hydroxypropyl, cellulose, micro- or nano-particles and fibers, and combinations thereof; (3) Wetting Agent—used to enhance the wettability of a dried foam. Examples of wetting agents include, but are not limited to, sodium lauryl sulfate, potassium laurate, disodium octadecyl succinimate, and combinations thereof; (4) Gelling Agent—used to stabilize air bubbles in the froth by causing the polymer dispersion to take the form of a gel which serves to reinforce cell walls. Examples of gelling agents include, but are not limited to, hydroxypropyl cellulose, hydroxyethyl cellulose, carboxymethyl cellulose and other modified cellulose ethers, and combinations thereof. Some surfactants can deliver more than one of the functions listed above. Therefore, although it is possible, it is not necessary to use a surfactant from each of the four categories in froth at one time.

Additional surfactants can include, but are not limited to, alkali metal (e.g., sodium or potassium), mono-, di-, and tri-alkanol (e.g., mono-, di-, or triethanol) amine and ammonium salts of lauryl sulfate, dodecylbenzene sulfates, alcohol ethoxy sulfates, isethionates, and the dibasic salt of N-octyldecylsulfosuccinimate, as well as combinations thereof.

These surfactants may or may not be different than those used as a dispersant to prepare the polymer dispersion. These surfactants serve both to assist in froth creation and help to stabilize the froth. Surfactants can be added in any amount suitable for frothing the polymer dispersion. In an embodiment, surfactants can be added in an amount from about 2% to about 15 or 20%, by weight of the composition. For any given formulation, there is an inherent capability of entrapping a fixed amount of air. During the frothing process, it is important that there is an adequate amount of air capable of frothing the polymer dispersion. If the air provided is less than adequate, the frothing capability of the polymer dispersion may not be fully realized and the resultant frothed polyolefin foam may not be optimal. Conversely, if the air supply is higher than what the polymer dispersion can handle, larger than normal sized air bubbles can be trapped inside the froth which can change the frothed polyolefin foam average pore size and distribution, which can lead to bursting during the drying process and ultimately either disrupt the frothed polyolefin foam uniformity and/or lead to the creation of defects inside the open cell structure of the frothed polyolefin foam.

The froth can include a binder. The binder can act as a glue to stick the dried polymer dispersion particles together. In the selection of the binder, the binder should exhibit beneficial characteristics such as softness and adhesiveness to provide overall mechanical strength in both wet and dry conditions, as well as elasticity to provide the open cell frothed polyolefin foam with resiliency. In an embodiment, the binder can be water soluble. Examples of water soluble binder include, but are not limited to, carboxymethyl cellulose, and modified protein. In an embodiment, the binder can be water dispersible. Examples of water dispersible binder include, but are not limited to, polyisoprene, vinyl acetate-ethylene copolymer, and styrene-butadiene rubber. The binder can be added to the froth in an amount from about 5 wt % to about 60 wt % of the total formulation polymer weight.

In an embodiment, the binder selected for use in the froth may provide sufficient adhesion but not sufficient mechanical strength. In such an embodiment, the resultant frothed polyolefin foam may exhibit good softness and cohesion, but lack tensile strength and elastic properties which can result in low resiliency and weak bending strength. In such an embodiment, the binder can be further cross-linked with a cross-linking agent. The resultant frothed polyolefin foam can then exhibit good softness, cohesion, resiliency, and bending strength. Examples of cross-linking agents include, but are not limited to, sulfur compounds (e.g., Curepaste 590 available from Para-Chem), peroxides (e.g., hydrogen peroxide), persulfate (e.g., potassium persulfate), azo compounds (e.g., bisisobutyronitrile), ethylene carbonate, propylene carbonate, ammonium zirconium carbonate, organic peroxides (e.g., 1,3,1,4-bis(tert-butylperoxyisopropyl)benzene, dicumyl peroxide, t-butyl cumyl peroxide, 2,5-di(t-butylperoxy)-2,5-dimethylhexane, n-butyl-4,4-di(t-butylperoxy)valerate, 1,1′-di(t-butylperoxy)-3,3,5-trimethylcyclohexane, 2,4-pentanedione peroxide, 1,1-bis(tert-butylperoxy)cyclohexane, 1,1-bis(tert-amylperoxy)cyclohexane, and benzoyl peroxide), and inorganic peroxides (e.g., hydrogen peroxide, barium peroxide, sodium peroxide, potassium peroxide, calcium peroxide, and magnesium peroxide). The suitable amount of cross-linking agent is dependent upon the type of cross-linking agent, cross-linking efficiency, degree of crystallinity of the polyolefin polymer, density of the frothed foam, amount of binder used, etc. A cross-linking agent can be utilized in an amount ranging from about 0.1 wt % to about 10 wt %. In an embodiment, the cross-linking of the binder can also be accomplished by other non-chemical cross-linking mechanisms such as electronic beam treatment. As will be described herein, the overall strength and elastic properties of frothed polyolefin foam can be improved when manufactured using a composition including highly crystalline polymer dispersion, a binder and a cross-linking agent.

### Preparation of Froth:

Froth can be prepared from the polymer dispersion by using a high shear, mechanical mixing process to entrain air or another gas in the aqueous phase of the polymer dispersion. The amount of air or other gas (where a gas in addition to or other than air is desired) to be incorporated in the froth can comprise at least about 80, 85 or 90 percent by volume of the resultant froth. In general, all components to be used in making the froth are mixed together with mild agitation to avoid entrapping air. Once all of the components are well mixed, the components are exposed to high shear mechanical mixing.

The froth can be prepared using any suitable equipment normally employed for frothing of aqueous liquids and dispersion. Any mixing or stirring device useful for preparation of aqueous particulate dispersions can be utilized in the preparation of the dispersion and in subsequent formulation and blending with surfactants and other additives, with care being taken to avoid entraining significant amounts of air in the blend before frothing begins. A kitchen mixer or other bladed mixing equipment is a suitable device. A continuous mixer from E.T. Oakes Corporation or a Chemical Foam System from Gaston Systems Incorporated are also suitable for commercial applications. When the blend is prepared, the same or different mixing device can then be operated to begin air entrapment in the formulated aqueous blend containing the polymer dispersion and any other additives, as desired.

To achieve the desired density of the final frothed polyolefin foam, the correct amount of frothing and air content can be determined by a simple experiment. The froth density can be measured by drawing off samples of the froth in cups of predetermined volume and weight, weighing the froth-filled cup and then calculating the density of the sample. The speed of the mixing device can then be increased or decreased to achieve the desired density of the froth.

### Drying or Drying and Curing of the Froth:

Drying of the froth to form the frothed polyolefin foam can be conducted in batch or continuous mode. Devices such as conventional forced air drying ovens or banks of infrared heating lamps or dielectric heating devices lining a tunnel or chamber in which the froth can be placed or conveyed through, in a continuous fashion, can be employed for drying. A combination of such drying sources may be employed, either simultaneously or sequentially applied, to dry the froth to form the foam. The temperature of the drying process can be selected according to the nature and the melting range of the polymer (as determined by the differential scanning calorimetry (DSC)) used to prepare the polymer dispersion and ultimately the frothed polyolefin foam.

The frothed polyolefin foam can be prepared by removing the liquid/aqueous elements of the froth. In an embodiment, the froth can be dried and converted to frothed polyolefin foam by heating it in a forced air drying oven, at a temperature suitable for optimum drying. As the nature of the polymer permits, the drying process can be conducted at the highest temperature feasible to remove water rapidly from the froth without destroying the viscosity of the polymer on the surface of the froth or causing significant (such as more than 30% volume) collapse of the partially dried froth. It is generally desired to perform the drying step at a temperature that approaches, but does not exceed, the polymer's melting range. The desired condition is to attain a temperature where the amorphous regions in the polymer can begin to coalesce while still maintaining sufficient viscosity to the heated polymer to avoid or to at least minimize collapse of the froth before the frothed polyolefin foam has become fully “dried” in its ultimate form and dimension and at least 95 weight percent of the water in the froth has been dried out. When the frothed polyolefin foam is dried in a continuous fashion, the drying temperature can be different at different drying zones. The drying temperature at a starting zone can be higher than the polyolefin's melting point since the frothed polyolefin foam at that zone still contains a lot of water. This can speed up the drying rate and reduce the required drying time.

The melting range of a polymer is determined by differential scanning calorimetry (DSC) techniques, and the temperatures bracketing the region of the DSC endotherm, or the final endotherm if more than one exists, just before a return to baseline on the DSC scan plot is the temperature range in which drying of the froth to form the finished frothed polyolefin foam is to be conducted. The drying range for the polymers can be from about 80 to about 150 deg C. During the drying process, by maintaining such a temperature, most of the polymer is able to fuse without a complete loss of polymer tensile strength and the bubble collapse that would otherwise ensure, if all crystalline portions of the polymer were to be melted.

The same temperature limitations for drying the froth foam must also be maintained for any curing or crosslinking. The curing temperature must be lower than the melting range of the polymer as described above.

In an embodiment, the froth can be extruded onto a conveyer device from which the frothed polyolefin foam can be recovered following the drying process. In an embodiment, the froth can be extruded or cast directly onto another substrate to which, when dried, it will adhere to form a laminated structure with the resultant frothed polyolefin foam on at least one side of the substrate. In an embodiment, the froth can be formed into a shaped profile, by forcing the froth through a die or other profile-inducing shaped structure, before the drying step is performed. In an embodiment, an embossing step can be conducted by application of shaped elements on a conveying belt for the froth during drying, or later in a separate thermal embossing step by application of a heated, shaped elements-bearing belt or wheel to a major surface of the frothed polyolefin foam. In an embodiment, the froth can be placed in a heated mold form. In such an embodiment, channels can be provided to conduct steam from the frothed polyolefin foam to the ambient atmosphere. Molded articles of frothed polyolefin foam that have a particular shape can be formed and can then be used in the fabrication of an absorbent article, such as absorbent articles used in hygiene and medical applications where body conformable articles can be desired.

Once the froth has been dried, the resultant frothed polyolefin foam can have an open cell foam structure wherein the internal pores or voids can be interconnected and penetrable. The open cell foam can be characterized by several structural parameters, such as, for example, density, average pore size and distribution, cell wall thickness, cell shape and uniformity, etc. To control formation of these structural parameters, several factors can be used which include, but are not limited to, type of polymer dispersion chemistry, type of surfactant chemistry, additional amount of the surfactants, type of binder, additional amount of binder, type of cross-linking agent, additional amount of cross-linking agent, dispersion polymer to water ratio (i.e., solids level), frothing equipment (i.e., kitchen friendly mixers, bench top, or commercial scale frothing units), amount of air introduced while mixing, drying rate, temperature, and other drying conditions.

### Additives:

The frothed polyolefin foam can further include additional components in amounts, depending upon the application for which they are designed, ranging from about 2 to about 100 percent on a dry basis weight of the polymer component. These optional ingredients can include, but are not limited to, fibers, non-swellable particles, or combinations thereof. Non-swellable particles include, but are not limited to, micro-particles, carbon black, silica gels, calcium carbonate, titanium dioxide powder, polymer particles, hollow glass spheres, thermally expandable microspheres, additional polymer dispersions, fragrances, anti-bacterials, moisturizers, soothers, medicaments, and combinations thereof. Frothed polyolefin foam intended for use in an absorbent article can contain bulk liquid absorbing material, such as short cotton fiber or other cellulose fiber evenly distributed throughout the frothed polyolefin foam. Fine particles of superabsorbent material can also be included in the frothed polyolefin foam. Fibers and/or non-swellable particles can provide enhanced stability to the frothed polyolefin foam and can also bring product benefits to the final frothed polyolefin foam. For example, if carbon black or calcium carbonate powder is added into the frothed polyolefin foam, the final frothed polyolefin foam can exhibit improved odor adsorbent properties. Other improved properties due to the addition of the fiber and/or non-swellable particles include, but are not limited to, mechanical strength, elasticity/stretchability, antimicrobial, electrical conductivity, fragrance, thermal isolation, and medical effect to the skin.

### EXAMPLES

### 1. Frothed Polyolefin Foams Having Different Degrees of Crystallinity

Five polyolefin dispersions were added to two frothing surfactants and were subjected to mechanical mixing in a KitchenAid® mixer at high speed (setting No. 10) for five (5) minutes to prepare froth with each polyolefin polymer chemistry. The froth with each polyolefin polymer chemistry was then cast into sheets by casting the froth directly onto a spunbond nonwoven as a substrate with different thicknesses controlled by metal rod diameters (⅛″, ¼″ and ½″). The sheets were then dried in an oven for 20 minutes. Table 1 below summarizes the codes prepared:

TABLE 1
Foam Code List

| | | Wt. % of | | Wt. % | | Wt. % | Drying | Liquid | Dry |
|---|---|---|---|---|---|---|---|---|---|
| | | Dispersion | | of | | of | Temp | Foam | Foam |
| | Polyolefin | before | Frothing | Surf. | Frothing | Surf. | Range | Density | Density |
| Code | Dispersion | frothing | Surf. 1 | 1 | Surf. 2 | 2 | (° C.) | (g/cc) | (g/cc) |
| 1-2 | HYPOD ® | 39.9% | Stanfax | 5% | Stanfax | 3.5% | 80-100 | 0.115 | |
| | 8510³ | | 320¹ | | 318² | | | | |
| 1-3 | Guard 55⁴ | 38.8% | Stanfax | 5% | Stanfax | 3.5% | 85-115 | 0.121 | N/A* |
| | | | 320 | | 318 | | | | |
| 1-4 | Shield 251⁵ | 35.0% | Stanfax | 5% | Stanfax | 3.5% | 85-115 | 0.111 | N/A* |
| | | | 320 | | 318 | | | | |
| 1-5 | Hydrocer | 39.4% | Stanfax | 5% | Stanfax | 3.5% | 85-115 | 0.126 | N/A* |
| | 257⁶ | | 320 | | 318 | | | | |
| 1-6 | Hydrocer | 38.8% | Stanfax | 5% | Stanfax | 3.5% | 85-115 | 0.107 | N/A* |
| | 77⁷ | | 320 | | 318 | | | | |

*The dried foams were weak and became powder upon finger touch. Therefore, no density measurement could be performed.
¹Stanfax 320 is an ammonium stearate solution commercially available from ParaChem with a solid level of 36 wt %.
²Stanfax 318 is a sodium lauryl sulfate solution commercially available from ParaChem with a solid level of 27 wt %.
³HYPOD ™ 8510 is polyethylene copolymer dispersion commercially available from Dow Chemical Co. with a solid level of 42 wt %.
⁴Guard 55 is pure polyethylene dispersion commercially available from Michelman (designated as Michem ® Guard 55).
⁵Shield 251 is pure polyethylene dispersion commercially available from Michelman (designated as Michem ® Shield 251).
⁶Hydrocer 257 is pure polyethylene dispersion commercially available from Shamrock (designated as Hydrocer 257).
⁷Hydrocer 77 is pure polyethylene dispersion commercially available from Shamrock (designated as Hydrocer 77).

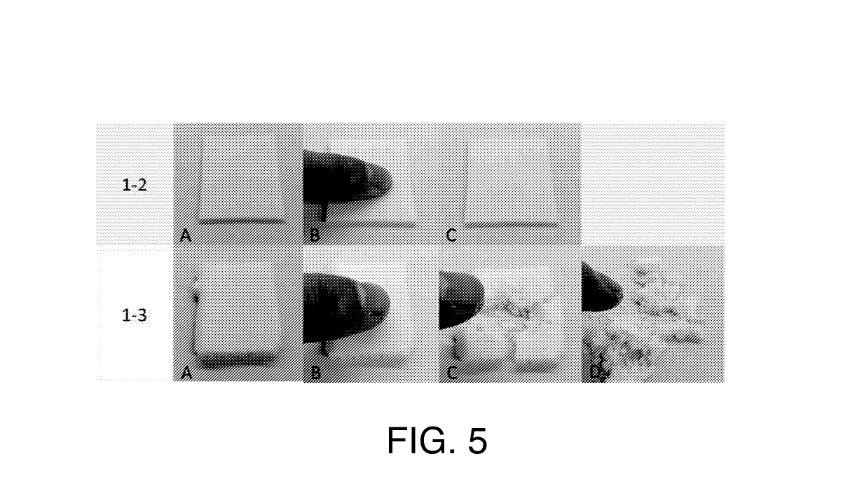

FIG. 5 provides a visual photographic comparison of frothed polyolefin foams produced from Code 1-2, the polyethylene copolymer dispersion (designated as HYPOD 8510), and Code 1-3, a pure polyethylene dispersion (designated as Michem® Guard 55). The visual photographic comparison of the two foams compares the two foams before (photo “A”), during (photo “B”), and after finger touching each foam (photo “C”). Photo “D” is an additional photograph of the foam manufactured with the pure polyethylene polymer dispersion following finger touch. As can be seen in the photographs, the foam prepared with the polyethylene copolymer was found to maintain its structure following finger touch. Conversely, the foam prepared with the highly crystalline pure polyethylene polymer dispersion failed to maintain its structure and became powder upon finger touch.

As the foam prepared with the highly crystalline pure polyethylene polymer was so weak that it failed to maintain its structure, the density of this foam could not be measured.

### 2. Highly Crystalline Polyolefin Dispersion Frothed Foams with a Binder

Four polyolefin dispersions were added to two frothing surfactants and were subjected to mechanical mixing in a KitchenAid® mixer at high speed (setting No. 10) for five (5) minutes to prepare froth with each polyolefin polymer chemistry. The froth with each polyolefin polymer chemistry was then cast into sheets by casting the froth directly onto a spunbond nonwoven as a substrate with different thicknesses controlled by metal rod diameters (⅛″, ¼″, ½″). The sheets were then dried in an oven for 20 minutes. To aid in the stability of the polyolefin chemistry, several materials were used as a binder to mix with the highly crystalline polyolefin dispersions in the formation of the froth to enhance the mechanical strength and integrity of the frothed polyolefin foams. The binders tested include polystyrene-butadiene rubber (SBR) such as Butanol® NS 104, Butanol® NS 209, Butanol® NS 222 (each commercially available from BASF); a fully-saturated elastomeric terpolymer such as HyStretch® V-43 (commercially available from Lubrizol Advanced Materials, Inc.); vinyl acetate ethylene latex dispersions such as Dur-O-Set® Elite Plus (DOS EP), Dur-O-Set® 351A (DOS 351A), and Dur-O-Set® Elite Ultra (DOS EU) (each commercially available from Celanese Emulsion Polymers); carboxymethyl cellulose such as CMC-7L commercially available from Aqualon; paint based material such as GLN9013 commercially available as a Glidden paint available from The Home Depot (contains 20-30% acrylic resin and 10-20% clay); synthetic rubber material such as polyisoprene (PIP) commercially available from Kraton Polymers; and other binders such as SB7201 commercially available from Momentive Specialty Chemicals Inc. (Synthebond™ 7201LSE, an acrylic emulsion pressure sensitive adhesive that does not use a tackifier) and PC4610 (Pro-Cote® 4610E Soy polymer, a protein based polymer) commercially available from DuPont. Table 2 below summarizes the frothed polyolefin foams prepared:

TABLE 2
Foam Code List

| | | | | | Wt % | | Wt % | Drying | Liquid |
|---|---|---|---|---|---|---|---|---|---|
| | | | Wt % of | | of | | of | Temp | Foam |
| | | | Mixed | Frothing | Surf. | Frothing | Surf | Range | Density |
| Code | Polyolefin Dispersion/Binder | | Dispersions | Surf. 1 | 1 | Surf. 2 | 2 | (° C.) | (g/cc) |
| 2-1 | 70% Shield 251 | 30% | 39.2% | Stanfax | 5% | Stanfax | 3.5% | 80-115 | 0.085 |
| | | NS104 | | 320 | | 318 | | | |
| 2-2 | 50% Shield 251 | 50% | 40.0% | Stanfax | 5% | Stanfax | 3.5% | 80-100 | 0.093 |
| | | NS104 | | 320 | | 318 | | | |
| 2-3 | 50% Guard 55 | 50% | 40.7% | Stanfax | 5% | Stanfax | 3.5% | 85-100 | 0.082 |
| | | NS104 | | 320 | | 318 | | | |
| 2-4 | 50% Hydrocer | 50% | 40.7% | Stanfax | 5% | Stanfax | 3.5% | 85-100 | 0.078 |
| | 257 | NS104 | | 320 | | 318 | | | |
| 2-5 | 50% Hydrocer | 50% | 39.5% | Stanfax | 5% | Stanfax | 3.5% | 85-100 | 0.121 |
| | 257 | HyStretch ® | | 320 | | 318 | | | |
| | | V-43 | | | | | | | |
| 2-6 | 50% Hydrocer | 50% DOS | 39.5% | Stanfax | 5% | Stanfax | 3.5% | 85-100 | 0.121 |
| | 257 | EP | | 320 | | 318 | | | |
| 2-7 | 50% Hydrocer 77 | 50% | 38.9% | Stanfax | 5% | Stanfax | 3.5% | 85-100 | 0.105 |
| | | NS104 | | 320 | | 318 | | | |
| 2-8 | 50% Hydrocer 77 | 50% | 38.9% | Stanfax | 5% | Stanfax | 3.5% | 85-100 | 0.107 |
| | | HyStretch ® | | 320 | | 318 | | | |
| | | V-43 | | | | | | | |
| 2-9 | 50% Hydrocer 77 | 50% DOS | 38.9% | Stanfax | 5% | Stanfax | 3.5% | 85-100 | 0.113 |
| | | EP | | 320 | | 318 | | | |
| 2-10 | 50% Guard 55 | 50% DOS | 38.9% | Stanfax | 5% | Stanfax | 3.5% | 85-100 | 0.104 |
| | | EU | | 320 | | 318 | | | |
| 2-11 | 97% Guard 55 | 3% CMC- | 37.3% | Stanfax | 5% | Stanfax | 3.5% | 85 | 0.121 |
| | | 7L | | 320 | | 318 | | | |
| 2-12 | 90% Guard 55 | 10% CMC- | 38.1% | Stanfax | 5% | Stanfax | 3.5% | 85 | 0.128 |
| | | 7L | | 320 | | 318 | | | |
| 2-13 | 50% Guard 55 | 50% DOS | 39.7% | Stanfax | 5% | Stanfax | 3.5% | 85-100 | 0.139 |
| | | 351A | | 320 | | 318 | | | |
| 2-14 | 50% Guard 55 | 50% DOS | 38.9% | Stanfax | 5% | Stanfax | 3.5% | 85-100 | 0.086 |
| | | EU | | 320 | | 318 | | | |
| 2-15 | 50% Hydrocer | 50% NS | 39.2% | Stanfax | 5% | Stanfax | 3.5% | 85-100 | 0.110 |
| | 259FDA¹ | 209 | | 320 | | 318 | | | |
| 2-16 | 50% Hydrocer | 50% | 39.2% | Stanfax | 5% | Stanfax | 3.5% | 85-100 | 0.100 |
| | 259FDA | NS222 | | 320 | | 318 | | | |
| 2-17 | 50% Hydrocer | 40% DOS | 38.8% | Stanfax | 5% | Stanfax | 3.5% | 85-100 | 0.093 |
| | 259FDA | EU, 10% | | 320 | | 318 | | | |
| | | CMC-7L | | | | | | | |
| 2-18 | 55% Hydrocer | 40% DOS | 38.9% | Stanfax | 5% | Stanfax | 3.5% | 92 | 0.171 |
| | 259FDA | 351A, 5% | | 320 | | 318 | | | |
| | | CMC-7L | | | | | | | |
| 2-19 | 60% Hydrocer | 40% | 40.1% | Stanfax | 5% | Stanfax | 3.5% | 80-90 | |
| | 257 | GLN9013 | | 320 | | 318 | | | |
| 2-20 | 60% Hydrocer | 40% | 39.4% | Stanfax | 5% | Stanfax | 3.5% | 80-90 | 0.118 |
| | 257 | SB7201 | | 320 | | 318 | | | |
| 2-21 | 60% Hydrocer | 40% | 28.3% | Stanfax | 5% | Stanfax | 3.5% | 80-90 | 0.192 |
| | 257 | PC4610 | | 320 | | 318 | | | |
| 2-22 | 60% Hydrocer | 40% PIP | 39.6% | Stanfax | 5% | Stanfax | 3.5% | 80-90 | 0.114 |
| | 257 | | | 320 | | 318 | | | |

¹Hydrocer 259FDA is pure polyethylene dispersion commercially available from Shamrock and is FDA approved (designated as Hydrocer 259FDA).

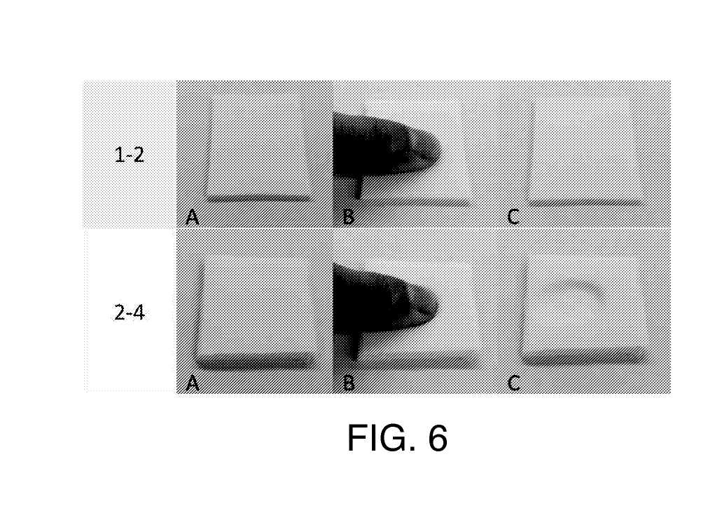

FIG. 6 provides a visual photographic comparison of frothed polyolefin foams produced from Code 1-2, the polyethylene copolymer dispersion (designated as HYPOD 8510), and Code 2-4, a pure polyethylene dispersion (designated as Hydrocer 257) which has been mixed with a binder (a polystyrene-butadiene rubber binder, Butanol® NS 104). The visual photographic comparison of the two foams is before (photo “A”), during (photo “B”), and after finger touching each foam (photo “C”). As can be seen in the photographs, the foam prepared with the polyethylene copolymer was found to maintain its structure following finger touch. The polyethylene copolymer foam was also able to demonstrate resiliency and elasticity following the finger touch as the foam was able to recover to its original structure. Conversely, the foam prepared with the highly crystalline pure polyethylene polymer dispersion and binder (without a cross-linking agent) exhibited improved mechanical strength and cohesion of its structure as the foam did not become powder following finger touch. The highly crystalline polymer and non-crosslinked binder foam, however, failed to exhibit resiliency and elasticity. As illustrated in FIG. 6, photo “C” of code 2-4, after being pressed by a finger, the deformation of the foam caused by the finger press remains in the foam as a finger mark.

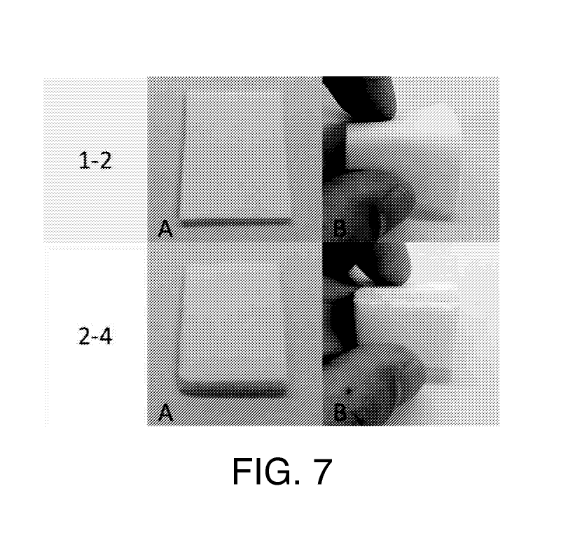

Additionally, while the highly crystalline polyethylene foam with a non-crosslinked binder was able to demonstrate improved mechanical strength, the improvement in mechanical strength was not enough to prevent the foam from breaking following bending of the foam. FIG. 7 provides a visual photographic comparison of frothed polyolefin foams produced from Code 1-2, the polyethylene copolymer dispersion (designated as HYPOD 8510), and Code 2-4, a pure polyethylene dispersion (designated as Hydrocer 257) which has been mixed with a binder (a polystyrene-butadiene rubber binder, Butanol® NS104). The visual photographic comparison of the two foams is before (photo “A”) and during (photo “B”) a bending action being exerted on the foams. As can be seen in the photographs, the foam prepared with the polyethylene copolymer was found to maintain its structure following the bending action. Conversely, the foam prepared with the highly crystalline pure polyethylene polymer dispersion and binder (without a cross-linking agent) exhibited that while the highly crystalline polyethylene foam with a non-crosslinked binder was able to demonstrate improved mechanical strength, the improvement in mechanical strength was not enough to prevent the foam from breaking following bending of the foam.

### 3. Highly Crystalline Polyolefin Frothed Foam with a Binder and a Cross-Linking Agent

To improve the mechanical strength, resiliency, elasticity, and cohesion of highly crystalline polyolefin frothed foam with a binder, a cross-linking agent was mixed with the polyolefin dispersion and the binder. A polyolefin dispersion was added to two frothing surfactants and was subjected to mechanical mixing in a KitchenAid® mixer at high speed (setting No. 10) for five (5) minutes to prepare froth with the polyolefin polymer chemistry. The froth was then cast into sheets by casting the froth directly onto a spunbond nonwoven as a substrate with different thicknesses controlled by metal rod diameters (⅛″, ¼″, ½″). To aid in the stability of the polyolefin chemistry, several materials were used as a binder to mix with the highly crystalline polyolefin dispersions in the formation of the froth to enhance the mechanical strength and integrity of the frothed polyolefin foams. A cross-linking agent was also provided to further enhance the stability of the frothed polyolefin foam. Table 3 below summarizes the foams which were prepared.

TABLE 3
Foam Code List

| | | | | | | | | | Drying | | Liquid |
|---|---|---|---|---|---|---|---|---|---|---|---|
| | | | | | | Wt % | | Wt % | Temp | | Foam |
| | Polyolefin | | Wt % of | Crosslinking | Frothing | of | Frothing | of | Range | Drying | Density |
| Code | Dispersion/Binder | | Dispersion | Agent (%) | Surf. 1 | Surf 1 | Surf 2 | Surf. 2 | (° C.) | Time | (g/cc) |
| 3-1 | 53% | 47% | 39.7% | 6% EC¹ | Stanfax | 5% | Stanfax | 3.5% | 80-90 | 20 | 0.116 |
| | Hydrocer | DOS | | | 320 | | 318 | | | | |
| | 257 | 909tsb⁵ | | | | | | | | | |
| 3-2 | 53% | 47% | 38.2% | 12% EC | Stanfax | 5% | Stanfax | 3.5% | 80-90 | 20 | 0.100 |
| | Hydrocer | DOS | | | 320 | | 318 | | | | |
| | 257 | 909tsb | | | | | | | | | |
| 3-3 | 42% | 58% | 46.3% | 5.5% EC | Stanfax | 5% | Stanfax | 3.5% | 80-90 | 20 | 0.111 |
| | Hydrocer | NS104 | | | 320 | | 318 | | | | |
| | 257 | | | | | | | | | | |
| 3-4 | 43% | 57% | 50.6% | 14% 590² | Stanfax | 1.8% | Stanfax | 5% | 140 | 20 | 0.113 |
| | Hydrocer | NS104 | | | 238⁴ | | 318 | | | | |
| | 257 | | | | | | | | | | |
| 3-5 | 50% | 50% | 50.6% | 14% 590 | Stanfax | 1.6% | Stanfax | 4.5% | 140 | 20 | 0.110 |
| | Hydrocer | NS104 | | | 238 | | 318 | | | | |
| | 257 | | | | | | | | | | |
| 3-6 | 50% | 50% | 50.7% | 2% | Stanfax | 1.6% | Stanfax | 4.5% | 120 | 40 | 0.150 |
| | Hydrocer | NS104 | | Luperox ® | 238 | | 318 | | | | |
| | 257 | | | 231³ | | | | | | | |

¹EC is ethylene carbonate.
²Curepaste 590 (commercially available from Royal Coatings & Specialty Polymers) is a sulfer containing cross-linking agent to rubber such as the NS104 commercially available from BASF.
³Stanfax 238 is a foaming surfactant containing three components: tetrapotassium pyrophosphate (TKPP: a buffering agent, emulsifier and dispersing agent), neutralizing agent (i.e., KOH) and thickener (i.e., T-111) at a dry weight ratio of 238:TKPP:KOH:T-111 = 1:0.67:0.07:1.4.
⁴Luperox ® 231 is an organic peroxide commercially available from Arkema with a molecular structure of 1,1-di(t-butylperoxy)-3,3,5-trimethylcyclohexane.
⁵DOS 909tsb is Dur-O-Set ® 909tsb, a tackifier which cross-links at 100° C., commercially available from Celanese Emulsion Polymers.

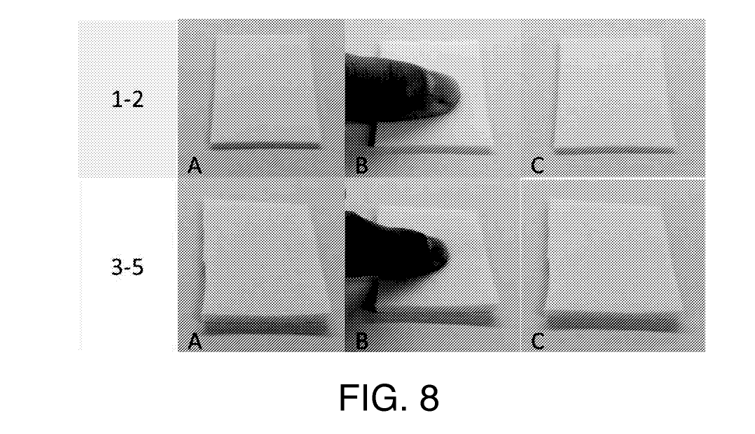

FIG. 8 provides a visual photographic comparison of frothed polyolefin foams produced from Code 1-2, the polyethylene copolymer dispersion (designated as HYPOD 8510), and Code 3-5, a pure polyethylene dispersion (designated as Hydrocer 257) which has been mixed with a binder (a polystyrene-butadiene rubber binder, Butanol® NS 104) and a crosslinking agent (Curepaste 590). The visual photographic comparison of the two foams is before (photo “A”), during (photo “B”), and after finger touching each foam (photo “C”). As can be seen in the photographs, the foam prepared with the polyethylene copolymer was found to maintain its structure following finger touch. The polyethylene copolymer foam was also able to demonstrate resiliency and elasticity following the finger touch as the foam was able to recover to its original structure. Additionally, the foam prepared with the highly crystalline pure polyethylene polymer dispersion, binder, and with a cross-linking agent maintained its structure and cohesion of its structure as the foam did not become powder following finger touch. Additionally, the highly crystalline polymer and cross-linked binder foam exhibited resiliency and elasticity. As illustrated in FIG. 8, photo “C” of code 3-5, after being pressed by a finger, the foam was able to return to its original shape and structure following the deformation of the foam caused by the finger press.

In the interests of brevity and conciseness, any ranges of values set forth in this disclosure contemplate all values within the range and are to be construed as support for claims reciting any sub-ranges having endpoints which are whole number values within the specified range in question. By way of hypothetical example, a disclosure of a range of from 1 to 5 shall be considered to support claims to any of the following ranges: 1 to 5; 1 to 4; 1 to 3; 1 to 2; 2 to 5; 2 to 4; 2 to 3; 3 to 5; 3 to 4; and 4 to 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by references, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An open cell foam comprising a composition comprising a highly crystalline polyolefin dispersion; a cross-linkable binder; and a surfactant.

2. The foam of claim 1 wherein the polyolefin is selected from polyethylene or polypropylene.

3. The foam of claim 1 wherein the binder is water soluble.

4. The foam of claim 3 wherein the binder is selected from carboxymethyl cellulose or modified protein.

5. The foam of claim 1 wherein the binder is water dispersible.

6. The foam of claim 5 wherein the binder is selected from polyisoprene, vinyl acetate-ethylene copolymer, or styrene-butadiene rubber.

7. The foam of claim 1 wherein the binder is cross-linked using a cross-linking agent.

8. The foam of claim 7 wherein the cross-linking agent is selected from sulfur compounds, peroxides, persulfates, azo compounds, ethylene carbonate, propylene carbonate, ammonium zirconium carbonate, organic peroxides and inorganic peroxides.

9. The foam of claim 1 wherein the binder is cross-linked using radiation or electromagnetism.

10. The foam of claim 1 further comprising fibers, non-swellable particles or combinations thereof.

11. A method of manufacturing an open cell foam, the method comprising the steps of:
a. producing a composition comprising a highly crystalline polyolefin dispersion, a surfactant, a cross-linkable binder, and a cross-linking agent;
b. mechanically mixing the composition with air to create a froth; and
c. drying the froth at a temperature below the melting point of the open cell foam and above the temperature at which the cross-linking agent can cross-link the binder.

12. The method of claim 11 wherein the polyolefin is selected from polyethylene or polypropylene.

13. The method of claim 11 wherein the binder is water soluble.

14. The method of claim 13 wherein the binder is selected from carboxymethyl cellulose or modified protein.

15. The method of claim 11 wherein the binder is water dispersible.

16. The method of claim 15 wherein the binder is selected from polyisoprene, vinyl acetate-ethylene copolymer, or styrene-butadiene rubber.

17. The method of claim 11 wherein the binder is cross-linked using a cross-linking agent.

18. The method of claim 17 wherein the cross-linking agent is selected from sulfur compounds, peroxides, persulfates, azo compounds, ethylene carbonate, propylene carbonate, ammonium zirconium carbonate, organic peroxides and inorganic peroxides.

19. The method of claim 11 wherein the binder is cross-linked using radiation or electromagnetism.

20. The method of claim 11 wherein the open cell foam further comprises fibers, non-swellable particles or combinations thereof.
